(19) United States
(12) Patent Application Publication
(10) Pub. No.: US 2007/0030983 A1
(43) Pub. Date: Feb. 8, 2007

(54) High efficiency audio reproduction

(76) Inventor: Ronaldus Maria Aarts, Geldrop (NL)

Correspondence Address: PHILIPS INTELLECTUAL PROPERTY & STANDARDS, P.O. BOX 3001, BRIARCLIFF MANOR, NY, 10510, US

(21) Appl. No.: 10/571,640

(22) PCT Filed: Sep. 15, 2004
(86) PCT No.: PCT/IB04/51771

§ 371 Date: Mar. 14, 2006

(30) Foreign Application Priority Data
Sep. 16, 2003 (EP) 03103398.8
May 26, 2004 (EP) 04102314.4

(51) Int. Cl. H04R 1/40

(52) U.S. Cl. 381/97; 381/98

(57) ABSTRACT

A device is arranged for producing a driving signal (V_{M}) for a transducer (7), such as a loudspeaker. The driving signal has a frequency substantially equal to a resonance frequency of the transducer and an amplitude controlled by an external signal (V_{E}). The device is arranged for automatically adjusting the frequency of the driving signal to the resonance frequency of the transducer, using a control path (8). The device may be part of a frequency adaptation device (1) for adapting a frequency range of an audio signal to the transducer (7).

The present invention relates to high efficiency audio reproduction. More in particular, the present invention relates to a device capable of producing a high efficiency driving signal for a transducer and a corresponding method therefore. The present invention further relates to a device for adapting the frequency range of an audio signal to a transducer and a corresponding method therefore.

It is well known that audio frequencies range from approximately 20 Hz to approximately 20 kHz. While the middle range (approx. 1-10 kHz) can be reliably reproduced by regular loudspeakers, special transducers are typically required for the lower and higher frequency ranges. High fidelity audio systems typically include small transducers (tweeters) for reproducing the high audio frequency range, and relatively large transducers (woofers) for the low range. The transducers required to faithfully reproduce the lowest audible frequencies (approx. 20-100 Hz) at a suitable sound volume take up a substantial amount of space. However, there is an increasing demand for miniature audio sets. It is obvious that the requirements of large transducers and small audio equipment are incompatible.

It has been proposed to solve this problem by using psycho-acoustic phenomena such as “virtual pitch”. By creating harmonics of low-frequency signal components it is possible to suggest the presence of such signal components without actually reproducing them.

United States Patent Specification U.S. Pat. No. 6,134,330 (Philips), for example, discloses an audio system provided with enhancing means for enhancing the audio signal. These known enhancing means comprise a harmonics generator for generating harmonics of a first part of the audio signal so as to create the illusion that the perceived audio signal includes lower frequency components than are really available.

Although this known solution works remarkably well, it is no substitute for actually reproducing low-frequency (bass) signal components.

It is therefore an object of the present invention to overcome these and other problems of the Prior Art and to provide a device for and a method of reproducing audio signals which allows a more efficient reproduction of the entire audio frequency range, and in particular of low-frequency signal components.

It is a further object of the present invention to provide a device and a method for reproducing audio signals which audio signals can be automatically adjusted to the transducer so as to provide maximum efficiency.

Accordingly, the present invention provides a device for producing a driving signal for a transducer, the driving signal having a frequency substantially equal to a resonance frequency of the transducer and an amplitude controlled by an external signal, which device is provided with control means for automatically adjusting the frequency of the driving signal to the resonance frequency of the transducer.

By driving the transducer at a frequency that is substantially equal to its resonance frequency, the transducer is extremely efficient, producing the maximum sound output power at a given electrical input power. By providing control means for automatically adjusting the frequency of the driving signal to the resonance frequency of the transducer, it is ensured that the transducer is always operating at its maximum efficiency, irrespective of the temperature, atmospheric pressure, and other factors. In addition, any spread in the transducer characteristics is automatically compensated. It is therefore possible to replace the transducer with a similar, but not identical, other transducer, without the need for manual tuning of the device.

The control means may control and/or adjust the driving signal frequency on the basis of one or more transducer properties, such as the (instantaneous) impedance. It is known that the impedance of the transducer is frequency-dependant. In particular, the impedance of a transducer involves a phase shift that is equal to zero at the (dominant) resonance frequency of the transducer. The present inventor has realized that determining this phase shift and controlling the frequency of the driving signal so as to minimize the phase shift is a convenient way of matching the driving signal frequency with the resonance frequency. Accordingly, in a preferred embodiment of the device of the present invention the control means comprise phase determining means for determining any phase shift introduced by the transducer.

More in particular, the phase determining means preferably comprise a combination unit for combining a first signal representative of the phase of the driving signal's voltage and a second signal representative of the driving signal's current so as to produce a phase difference signal, and a control unit for producing a frequency control signal on the basis of the phase difference signal. Such an arrangement allows the phase of the driving signal to be used to control the frequency of the same signal.

In a first embodiment, the first signal is the driving signal. That is, the driving signal is combined with a second signal to produce a phase difference signal. In a second embodiment, the first signal is an auxiliary oscillator signal. In this second embodiment, an auxiliary oscillator signal is provided, typically but not necessarily phase-shifted over 90° (π/2 radians), in addition to a main oscillator signal from which the driving signal is derived. With such an auxiliary oscillator signal an improved phase detection may be achieved.

In an advantageous embodiment, the device further comprises a phase compensation unit for introducing a compensatory phase shift in the auxiliary oscillator signal so as to produce a phase shifted auxiliary oscillator signal. The compensatory phase shift is designed to be substantially equal to any phase shift introduced by amplifiers, filters and any other components.

The device may further comprise a resistor arranged in series with the transducer for producing the second signal in response to the driving current. That is, the driving current passing through the resistor produces the second signal. As a result, the phase of the second signal is equal to the phase of the driving current Additionally, or alternatively, the device of the present invention may further comprise an acceleration detector for detecting an acceleration of the transducer, and/or a displacement detector for detecting a displacement of the transducer.

The device of the present invention may further comprise a generator for generating an oscillation signal having a frequency substantially equal to the resonance frequency of the transducer, and a further combination unit for combining the oscillation signal with an amplitude control signal so as to produce the amplitude controlled driving signal.

In addition, the device may further comprise an amplifier for amplifying the driving signal, and/or a low-pass filter for filtering the driving signal.

The present invention further provides a frequency adaptation device for adapting a frequency range of an audio signal to a transducer, the device comprising:
detection means for detecting first signal components in a first audio frequency range,
generator means for generating second signal components in a second audio frequency range,
amplitude control means for controlling the amplitude of the second signal components in response to the amplitude of the first signal components, and
control means for determining the second audio frequency range on the basis of transducer properties,
wherein the second audio frequency range is substantially narrower than the first audio frequency range, and wherein the transducer has a maximum efficiency at the second audio frequency range.

By generating second signal components in a second audio frequency range which is substantially narrower than the first frequency range, the amplitude of the second signal components being controlled in response to the amplitude of the first signal components, the energy of the audio signal is concentrated in the second frequency range. As a result, the bandwidth of the first frequency range is effectively reduced and the energy of the audio signal is concentrated in a substantially narrower (second) range. This has the advantage that the energy of the audio signal can be concentrated in a range in which a transducer is particularly efficient, thus resulting in a more efficient sound production. The second frequency range can be extremely narrow, effectively comprising only the frequency at which the transducer is most efficient, typically the resonance frequency. It is preferred that the second frequency range is partially or entirely within the first frequency range.

In a preferred embodiment, the control means are arranged for automatically controlling the second frequency range on the basis of transducer properties, such as the (instantaneous) impedance.

The present invention also provides a method of producing a driving signal for a transducer, the driving signal having a frequency substantially equal to a resonance frequency of the transducer and an amplitude controlled by an external signal, the method comprising the step of automatically adjusting the frequency of the driving signal to the resonance frequency of the transducer.

The method may advantageously further comprise the step of determining any phase shift introduced by the transducer. In a preferred embodiment, the method of the present invention further comprises the steps of combining a first signal representative of the phase of the driving signal's voltage and a second signal representative of the driving signal's current so as to produce a phase difference signal, and producing a frequency control signal on the basis of the phase difference signal. The first signal may be the driving signal or an auxiliary oscillator signal. In the latter case, the method may further comprise the step of introducing a compensatory phase shift in the auxiliary oscillator signal so as to produce a phase shifted auxiliary oscillator signal. The second signal may be produced in response to the driving current of the transducer.

In further advantageous embodiments, the method may additionally or alternatively comprise the step of detecting an acceleration or a displacement of the transducer.

It is preferred that the method further comprises the steps of generating an oscillation signal having a frequency substantially equal to the resonance frequency of the transducer, and combining the oscillation signal with an amplitude control signal so as to produce the amplitude controlled driving signal.

The method may further comprise the steps of amplifying and/or filtering the driving signal.

The present invention additionally provides a frequency adaptation method for adapting a frequency range of an audio signal to a transducer, the method comprising the steps of selecting a frequency range, detecting signals in the selected frequency range, and producing a driving signal for a transducer in accordance with the method defined above.

The present invention will further be explained below with reference to exemplary embodiments illustrated in the accompanying drawings, in which:

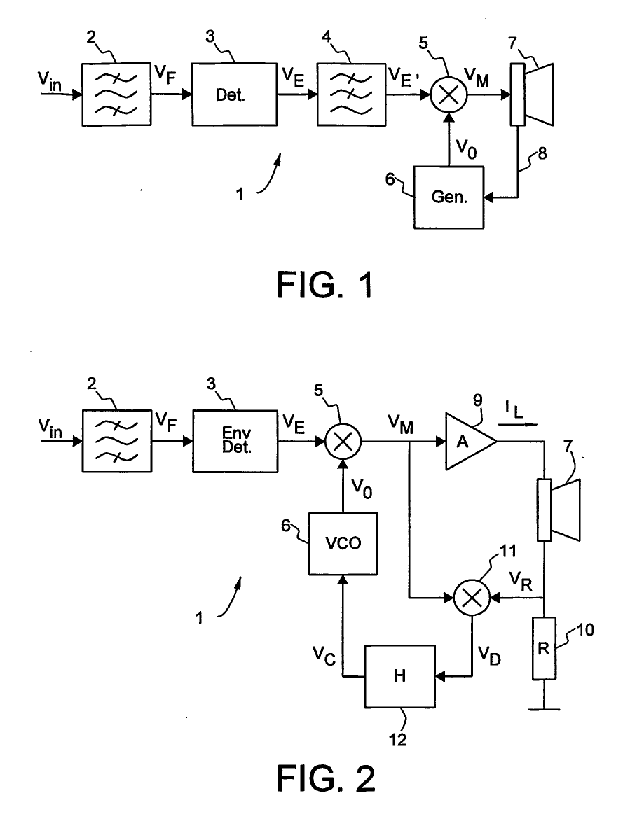

FIG. 1 schematically shows a first embodiment of a device according to the present invention.

FIG. 2 schematically shows a second embodiment of a device according to the present invention.

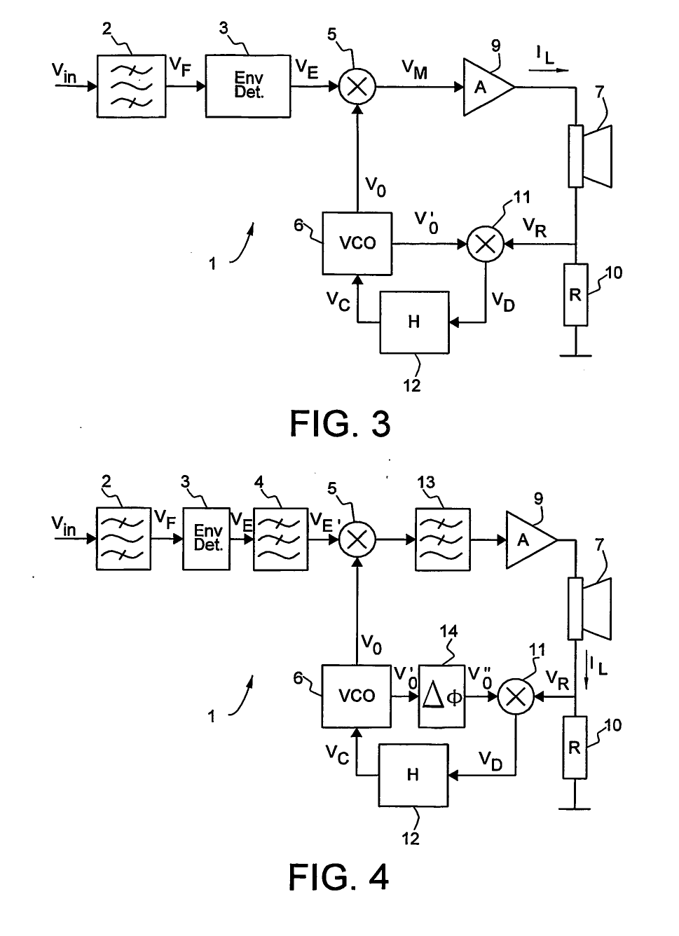

FIG. 3 schematically shows a third embodiment of a device according to the present invention.

FIG. 4 schematically shows a fourth embodiment of a device according to the present invention.

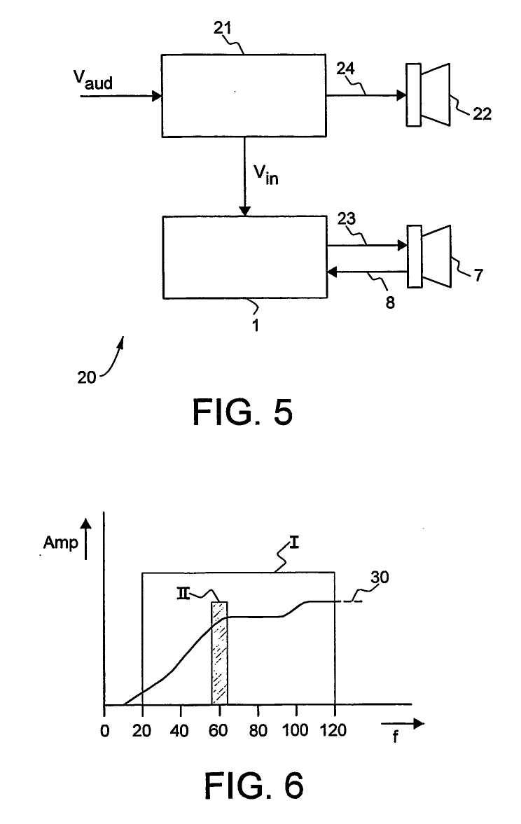

FIG. 5 schematically shows an audio system in accordance with the present invention.

FIG. 6 schematically shows a first and a second frequency range in accordance with the present invention.

The device 1 shown merely by way of non-limiting example in FIG. 1 comprises a first filter 2, a detector 3, a second filter 4, a combination unit 5, a generator 6, and a control path 8. A transducer 7 is coupled to the combination unit 5.

The device 1 of FIG. 1, which serves to adapt a frequency range of an audio signal to a transducer, comprises two parts: a first part consisting of the first filter 2, the detector 3 and the (optional) second filter 4, and a second part consisting of the combination unit 5, the generator 6 and the control path 8. The first part serves to produce an amplitude control signal on the basis of a selected frequency range of an (audio) input signal, while the second part serves to produce an amplitude controlled transducer driving signal.

The band-pass (first) filter 2, the detector 3 and the low-pass (second) filter 4 produce an amplitude control (that is, modulating) signal which is based on an input signal Vᵢₙ. This input signal Vᵢₙ is typically an audio signal, in particular the bass (low-frequency) part of an audio signal. The band-pass filter 2, which in some embodiments may be replaced with a low-pass filter, selects a frequency range and outputs an audio signal V_{F} having a limited frequency-range, for example 20 Hz to 120 Hz. The signal components of this selected frequency range are detected in the detector 3, which produces an envelope (that is, amplitude control) signal V_{E}. The detector 3 preferably is an envelope detector known per se but which may also be a peak detector known per se. In a very economical embodiment, the detector 3 may be constituted by a diode. It is noted that the second (low-pass) filter 4 merely serves to smooth the envelope signal V_{E} and may be omitted.

As explained above, the output signal V_{E} of the (envelope) detector 3 represents the amplitude of the input signal components present in a first frequency range (I in FIG. 6) selected by the filter 2. This signal V_{E} is subsequently used as an amplitude control signal. To this end, the combination unit 5, which in the embodiment shown is constituted by a multiplier, combines (multiplies) this amplitude control signal V_{E} with an oscillator signal V₀ generated by the generator (oscillator) 6 so as to form a driver signal V_{M} for driving the transducer 7. This driver signal V_{M} will have a frequency defined by the generator 6 and an amplitude defined by the signal V_{E}′ (or, if the second filter 4 is not present, V_{E}).

As will later be explained in more detail with reference to FIG. 6, the frequency of the generator 6 is substantially equal to the resonance frequency of the transducer 7. This allows the transducer to operate at its maximum efficiency. A suitable transducer is described in European Patent Application No. 03103396.2 (PHNL031135). Although the transducer 7 is typically constituted by a loudspeaker, other transducers can also be envisaged, such as so-called “shakers” that cause other objects to vibrate. The single transducer 7 may be replaced with a group of two or more transducers.

The control path 8 serves to control the frequency of the generator 6 and, more in particular, to keep the generator frequency substantially at a selected resonance frequency of the transducer (transducers typically have multiple resonance frequencies but preferably the resonance frequency is selected at which the desired sound output is achieved), for example 60 Hz. The control path 8 allows the generator 6 to adjust the frequency (and preferably also the phase) in dependence on transducer parameters such as the (instantaneous) impedance (or its absolute value), the actual movement of the vibration surface of the transducer, and/or sound pressure.

It will be clear to those skilled in the art that these parameters make it possible to determine the efficiency (the output power divided by the input power) of the transducer. As the efficiency will typically vary with the frequency, an adjustment of the frequency will allow the efficiency to be optimized. To this end the generator may introduce small (and possibly random) frequency variations to determine the efficiency at various frequencies around the current value. If at any of those alternative frequencies the efficiency is greater, the set value of the frequency may be altered. In this way, automatic tuning of the generator 6 may be provided, even in the absence of the control path 8. However, it is preferred to directly control the frequency of the generator without introducing any frequency variations.

To directly control the frequency of the generator 6, the control path 8 may feed a suitable frequency control signal to the generator 6, this frequency control signal being derived from one or more transducer parameters. In a preferred embodiment, the phase of the current IL passing through the transducer 7 is used to control the generator frequency, as schematically shown in FIG. 2. The generator 6 is preferable constituted by a VCO (Voltage Controlled Oscillator) known per se.

The device 1 of FIG. 2 also comprises a (first) filter 2, an envelope detector 3, a combination unit (multiplier) 5, and a generator 6. The second filter 4 has been deleted, while an amplifier 9 has been inserted between the combination unit 5 and the transducer 7 to provide a suitable driving current I_{L} for the transducer 7. The amplifier 9, and consequently the driving current I_{L}, is controlled by the driving voltage V_{M}.

In the exemplary embodiment of FIG. 2, the control path 8 is shown to comprise a resistor 10, a further (or second) combination unit 11, and a control unit 12. The driving current I_{L} passes through the transducer 7 and the resistor 10 to ground (or a suitable return connection), generating a resistor voltage V_{R} over the resistor 10. The combination unit 11, which may also be constituted by a multiplier, combines (multiplies) this resistor voltage V_{R} with the driving voltage V_{M} to produce a combined voltage V_{D} that is passed to the control unit 12. The control unit 12, which may be constituted by a low-pass filter, converts the combined voltage V_{D} into a suitable generator control voltage V_{C} that controls the frequency of the generator 6.

As mentioned above, the control path determines the phase of the driving current I_{L}. In mathematical terms, this may be expressed as follows.

The driving voltage V_{M} is the product of the generator signal V₀ and the amplitude signal V_{E}:
V_{M}=V_{E}·V₀=V_{E}·sin(ωt),
where ω=2π. f, and f being the generator frequency. The magnitude of the resistor voltage V_{R} over the resistor R is C times the magnitude of the driving voltage V_{M}, where C depends on the impedance of the transducer 7, the resistor 10, and the gain of the amplifier 9. As the transducer 7 introduces a phase shift φ, the resistor voltage V_{R} can now be written as:
V_{R}=C˜V_{E}·sin(ωt+φ)

The phase shift φ is frequency-dependent and substantially equals zero at the resonance frequency of the transducer 7. When this resistor signal V_{R} is multiplied with the driving signal V_{M} by the combination unit 11, the combined signal V_{D} can be written as:
V_{D}=V_{M}·V_{R}=V_{E}·sin(ωt)·C·V_{E}·sin(ωt+φ), or
V_{D}=½·C·V_{E}²·{cos(φ)−cos(2ωt+φ}.
Low-pass filtering at the control unit 12 (transfer function H) will result in:
V_{C}=½·C·V_{E}²·cos(φ),
which is independent of the frequency ω (=2π·f) and is at a maximum for φ=0. The generator 6 is therefore, in this embodiment, arranged for maximizing the control voltage V_{C}, as this will make the generator frequency equal to the resonance frequency.

It is noted that the circuit arrangement of FIG. 2 is merely exemplary and that the principles of the present invention can be applied equally well in other circuit arrangements. For example, the resistor 10 could be arranged between the amplifier 9 and the transducer 7. Alternatively, an additional transducer (pick-up element) could be used to determine (the phase of) the current passing through the transducer. Also, additional transducers could be used to register the acceleration, velocity and/or excitation of the transducer to determine transducer parameters, such any phase difference introduced by the transducer 7. If the transducer 7 is constituted by a loudspeaker, for example, an acceleration detector mounted on the cone can be used, or a displacement detector, for example one using laser technology.

It is further noted that the device 1 may be implemented using analog and/or digital techniques. In case digital techniques are used, those skilled in the art will recognize that suitable D/A (digital/analog) and A/D (analog/digital) converters may be present in the device 1. In-digital embodiments the control unit 12 may be constituted by a microcontroller or a microprocessor.

The embodiment of FIG. 3 also comprises a filter 2, a detector 3, a first combination unit 5, an amplifier 9, a resistor 10, a second combination unit 11, a control unit 12 and a generator 6. However, in this embodiment the generator 6 is a so-called quadrature generator, arranged for generating two output signals having the same frequency but a mutual phase difference of 90° (=π/2 radians). These generator signals can therefore be written as sin(ωt) and cos(ωt) respectively. In the embodiment of FIG. 3 this second generator signal V₀′=cos(ωt) is fed to the further combination unit (multiplier) 11, instead of the driving signal V_{M}. The output signal V_{D} of the second combination unit 11 can now be written as:
V_{D}=V₀′·V_{R}=cos(ωt)·C·V_{E}·sin(ωt+φ), or
V_{D}=½·C·V_{E}·{sin(2ωt+φ)+sin(φ)}
Low-pass filtering by the control unit 12 yields for the control voltage V_{C}:
V_{C}=½·C·V_{E}·sin(φ)
which is independent of the frequency ω (=2π·f) and is equal to zero for φ=0. The generator 6 is therefore, in this embodiment, arranged for making the control voltage V_{C} equal to zero, as this will make the generator frequency equal to the resonance frequency.

It is noted that quadrature oscillators are well known in the art. A particularly economical and suitable embodiment of a digital quadrature oscillator comprises a multi-vibrator producing a signal having four times the desired generator frequency, and a flip-flop dividing the signal by a factor of two. Dividing the resulting signal, which has twice the desired frequency, by two on the rising edges of the digital signal produces the first generator signal V₀=sin(ωt), while dividing on the falling edges produces the second generator signal V₀′=cos(ωt). Although such an embodiment is advantageous as there is no need for the multi-vibrator signal to be symmetrical, the particular configuration of the generator 6 is not essential to the present invention.

The embodiment of FIG. 4 is largely identical to the embodiment of FIG. 3. However, a (second) filter 4 has been added to low-pass filter the detector output signal V_{E}, as in FIG. 1. Also, a (third) low-pass filter 13 has been inserted between the combination unit 5 and the amplifier 9 so as to low-pass filter the combined signal V_{M} output by the combination unit prior to amplification. These optional filters 4 and 13 remove any undesirable signal components.

In addition, a phase compensation unit 14 has been added to compensate for any phase shifts introduced by the amplifier 9 (and/or the third filter 13). This phase compensation unit 14 adds a phase shift Δφ to the second generator signal V₀′ so as to obtain a phase shifted second generator signal V₀″=cos(ωt+Δφ). The correct value of the phase shift Δφ may be determined experimentally, temporarily replacing the transducer 7 with a resistor to eliminate any transducer phase shift. The addition of the phase compensation unit 14 allows a more accurate tuning of the generator 6.

In all embodiments, a limiter known per se could be arranged between the combination unit (multiplier) 11 and the connection between transducer 7 and the resistor 10. This would allow the combination unit 11 to be implemented very economically as an EXOR gate.

An audio system embodying the present invention is schematically illustrated in FIG. 5. The audio system 20 is shown to comprise a first audio processing unit 21 and a second audio processing unit 1. The first audio processing unit 21 receives an audio input signal V_{aud} from a suitable source, such as a CD player, a DVD player, an MPEG player, a radio tuner, a television tuner, a computer hard disc, the Internet, or another source. The low-frequency part of the audio input signal V_{aud} is passed on to the second audio processing unit 2 as an input signal Vᵢₙ, while the mid- and high-frequency parts are processed in the first audio processing device 21 and are then fed to the transducer (or set of transducers) 22 via a connection 24. The second audio processing unit 1, which may be identical to the device according to any of FIGS. 1 to 4, processes the input signal Vᵢₙ and outputs the processed signal to the transducer 7 via a connection 23. In accordance with the present invention, a control path 8 is provided from the transducer 7 to the second audio processing unit 1 to adjust the generator frequency of the audio processing unit 1.

In FIG. 6 a graph showing an audio frequency distribution is schematically depicted. The graph 30 indicates the amplitude Amp (vertical axis) of an audio signal at a particular frequency f (horizontal axis). As shown, the audio signal contains virtually no signal components below approximately 10 Hz. As the following discussion will focus on the low-frequency part of the graph 30, the mid- and high-frequency parts of the graph have been omitted for the sake of clarity of the illustration.

In the frequency adaptation device of the present invention, a first frequency range is mapped onto a second, smaller frequency range which is preferably contained in the first frequency range. In the non-limiting example of FIG. 6, a first frequency range I is the range from 20 Hz to 120 Hz, while a second range II is the range around 60 Hz, for example 55-65 Hz. This first range I substantially covers the “low-frequency” part of an audio signal, whereas the second range II of FIG. 6 is chosen so as to correspond with a particular transducer, such as a loudspeaker, and will depend on the characteristics of the transducer. This second range II corresponds with the frequencies at which the transducer is most efficient, resulting in the highest sound production.

It will be understood that the size (bandwidth) of the second range II may also depend on the characteristics of the transducer(s). A transducer or array of transducers having a wider range of frequencies at which it is most efficient (possibly multiple resonance frequencies) will benefit from a wider second range II. Transducers or arrays of transducers having a single most efficient frequency (typically the resonance frequency) may benefit from an extremely narrow second range II as this will concentrate all energy in said single frequency.

It is noted that in the example shown the second range II is located within the first range I. This means that the first range I is effectively compressed and that no frequencies outside the first range are affected.

Accordingly, the device of the present invention can also be defined as a device for driving a transducer with an amplitude modulated signal, the device comprising: generating means for generating a signal having a frequency, modulating means for amplitude modulating the generated signal with a modulating signal, feedback means for providing a feedback signal from the transducer to the generating means, wherein the feedback means are arranged for adjusting the frequency of the generated signal such that it is substantially equal to a resonance frequency of the transducer.

The present invention may advantageously be applied in electronic consumer apparatus, such as television sets, audio sets, in-house cinema systems, car audio systems, laptop computers, and desktop computers. In particular in so-called flat panel television sets the present invention may improve the sound quality, as in such sets the space available for loudspeakers is typically limited. Replacing a bass speaker with a relatively small resonant transducer, driven at its resonance frequency in accordance with the present invention, will significantly improve the perception of the bass sound while requiring a very limited amount of space.

The present invention is based upon the insight that the driving signal frequency of a resonant transducer may be accurately tuned by providing a feedback path from the transducer to the generator producing the driving signal frequency. The present invention benefits from the further insight that the phase of the driving current can be used effectively to determine whether the transducer is operating at its resonance frequency. It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device for producing a driving signal (V_{M}) for a transducer (7), the driving signal having a frequency substantially equal to a resonance frequency of the transducer and an amplitude controlled by an external signal (V_{E}), which device is provided with control means (8; 10, 11, 12) for automatically adjusting the frequency of the driving signal to the resonance frequency of the transducer.

2. The device according to claim 1, wherein the control means (8; 10, 11, 12) comprise phase determining means (11, 12) for determining any phase shift introduced by the transducer (7).

3. The device according to claim 2, wherein the phase determining means comprise a combination unit (11) for combining a first signal (V_{M}, V₀′, V₀″) representative of the phase of the driving signal's voltage and a second signal (V_{R}) representative of the driving signal's current so as to produce a phase difference signal (V_{D}), and a control unit (12) for producing a frequency control signal (V_{C}) on the basis of the phase difference signal (V_{D}).

4. The device according to claim 3, wherein the first signal is the driving signal (V_{M}).

5. The device according to claim 3, wherein the first signal is an auxiliary oscillator signal (V₀′, V₀″).

6. The device according to claim 5, further comprising a phase compensation unit (14) for introducing a compensatory phase shift in the auxiliary oscillator signal (V₀′) so as to produce a phase shifted auxiliary oscillator signal (V₀″).

7. The device according to claim 3, further comprising a resistor (10) arranged in series with the transducer (7) for producing the second signal (V_{R}) in response to the driving current (I_{L}).

8. The device according to claim 1, further comprising an acceleration detector for detecting an acceleration of the transducer (7).

9. The device according to claim 1, further comprising a displacement detector for detecting a displacement of the transducer (7).

10. The device according to claim 1, further comprising a generator (6) for generating an oscillation signal (V₀) having a frequency substantially equal to the resonance frequency of the transducer, and a further combination unit (5) for combining the oscillation signal (V₀) with an amplitude control signal (V_{E}) so as to produce the amplitude controlled driving signal (V_{M}).

11. The device according to claim 1, further comprising an amplifier (9) for amplifying the driving signal (V_{M}).

12. The device according to claim 1, further comprising a low-pass filter (13) for filtering the driving signal (V_{M}).

13. A frequency adaptation device (1) for adapting a frequency range of an audio signal to a transducer (7), the device comprising a filter (2) for selecting a frequency range, a detector (3) for detecting signals in the selected frequency range, and a device for producing a driving signal (V_{M}) for a transducer (7) according to claim 1.

14. A frequency adaptation device (1) for adapting a frequency range of an audio signal to a transducer (7), the device comprising:
detection means (3) for detecting first signal components in a first audio frequency range (I),
generator means (6) for generating second signal components in a second audio frequency range (II), and
amplitude control means (5) for controlling the amplitude of the second signal components in response to the amplitude of the first signal components, and
control means (8; 10, 11, 12) for determining the second audio frequency range (II) on the basis of transducer properties,
wherein the second audio frequency range (II) is substantially narrower than the first audio frequency range (1), and wherein the transducer (7) has a maximum sensitivity at the second audio frequency range (II).

15. The device according to claim 14, wherein the control means (8; 10, 11, 12) are arranged for automatically controlling the second frequency range (II) on the basis of transducer properties.

16. A method of producing a driving signal (V_{M}) for a transducer (7), the driving signal having a frequency substantially equal to a resonance frequency of the transducer and an amplitude controlled by an external signal (V_{E}), the method comprising the step of automatically adjusting the frequency of the driving signal to the resonance frequency of the transducer.

17. The method according to claim 16, further comprising the step of determining any phase shift introduced by the transducer (7).

18. The method according to claim 17, further comprising the steps of combining a first signal (V_{M}, V₀′, V₀″) representative of the phase of the driving signal's voltage and a second signal (V_{R}) representative of the driving signal's current so as to produce a phase difference signal (V_{D}), and producing a frequency control signal (V_{C}) on the basis of the phase difference signal (V_{D}).

19. The method according to claim 18, wherein the first signal is the driving signal (V_{M}).

20. The method according to claim 18, wherein the first signal is an auxiliary oscillator signal (V₀′, V₀″).

21. The method according to claim 20, further comprising the step of introducing a compensatory phase shift in the auxiliary oscillator signal (V₀′) so as to produce a phase shifted auxiliary oscillator signal (V₀″).

22. The method according to claim 18, further comprising the step of producing the second signal (V_{R}) in response to the driving current (I_{L}).

23. The method according to claim 16, further comprising the step of detecting an acceleration of the transducer (7).

24. The method according to claim 16, further comprising the step of detecting a displacement of the transducer (7).

25. The method according to claim 16, further comprising the steps of generating an oscillation signal (V₀) having a frequency substantially equal to the resonance frequency of the transducer, and combining the oscillation signal (V₀) with an amplitude control signal (V_{E}) so as to produce the amplitude controlled driving signal (V_{M}).

26. The method according to claim 16, further comprising the step of amplifying the driving signal (V_{M}).

27. The method according to claim 16, further comprising the step of filtering the driving signal (V_{M}).

28. A frequency adaptation method for adapting a frequency range of an audio signal to a transducer (7), the method comprising the steps of selecting a frequency range, detecting signals in the selected frequency range, and producing a driving signal (V_{M}) for a transducer (7) in accordance with claim 16.
